(19) United States
(12) Patent Application Publication
(10) Pub. No.: US 2013/0093593 A1
(43) Pub. Date: Apr. 18, 2013

(54) Smoke and Carbon Monoxide Detector, Alarm, Transmitter, and Cut out switch system

(71) Applicant: John H. Woods, North Chicago, IL (US)

(72) Inventor: John H. Woods, North Chicago, IL (US)

(21) Appl. No.: 13/275,026

(22) Filed: Oct. 17, 2011

(51) Int. Cl. G08B 17/10

(52) U.S. Cl. 340/628

(57) ABSTRACT

The present invention discloses a smoke and carbon monoxide detector, alarm, transmitter and cutout switch system. The device is designed to sound an alarm and transmit electronic signals to cutout switches causing interruption in electrical and/or gas supply.

### REPLACEMENT SPECIFICATION

This substitute specification includes no new matter

### FIELD OF THE INVENTION

The present invention relates generally to the field of smoke and carbon monoxide detection systems. More specifically, the device embodies a smoke and carbon monoxide detector, alarm, signal transmitter and cutout switch system. The invention becomes functional once retrofitted inside closed environments and operates with a high degree of efficiency and safety.

### BACKGROUND OF THE INVENTION

Smoke and carbon monoxide detection systems have been commercialized for a great deal of time. Such systems sound an alarm which alerts inhabitants of a closed environment of potentially dangerous smoke or carbon monoxide levels. The conventional smoke detector (See, U.S. Pat. No. 7,515,058) will only sound an alarm, without actually becoming a deterrent in the event of smoke infiltration inside a dwelling. Faulty appliances or exhaust vents may cause large carbon monoxide build ups inside a closed environment. High levels of poisonous gases are sometimes avoided by those who react within the time constraints and manage to shut off the power or gas supply feeding the appliances. Other times, the carbon monoxide detector or smoke alarm may sound, but the person may be sleeping, incapacitated or simply away from home. In such cases the alarm goes off unnoticed and without any reaction from inhabitants or authorities.

The more gas and electricity that people use the greater the risk for airborne smoke or carbon monoxide accumulations to occur. Such particles become inhaled by the inhabitants and then create potentially life threatening situations. Carbon monoxide is known to be a colorless and odorless life threatening gas. Once inhaled, carbon monoxide triggers the human body to slowly become incapacitated. Infiltrations of carbon monoxide make it impossible for blood to carry oxygen to vital internal organs or tissue. The simplicity and inefficiency of today's smoke detectors creates difficulty in detecting such a dangerous gas. Most detectors incorporate a housing containing a smoke sensor, carbon monoxide sensor, signal transmittal apparatus and an alarm system (See, U.S. Pat. No. 5,801,633, U.S. Pat. No. 6,819,252).

Some improvements have been brought to the conventional carbon monoxide detector over the past decade. Developments such as illumination of paths of egress once the alarm system is triggered (See, U.S. Pat. No. 5,587,705) are already being commercialized and implemented. Other systems have brought innovations such as wireless smoke detection devices or high efficiency and dependability systems.

### SUMMARY OF THE INVENTION

A device is provided for detection of smoke and carbon monoxide inside a closed environment. The detection system is designed to trigger an alarm and transmit an electronic signal to cutout switches. The system operates inside closed environments and is an improvement over prior systems while deterring hazardous gases or smoke that threaten human life.

In another embodiment the alarm component sends an electronic signal to cutout switches. Such switches, when activated, will open and cause an interruption of power for the specific appliances or areas that are monitored. The cutout switch component may also cause a gas valve to close while further shutting off the gas supply. Once said signal is transmitted and the switches are activated, the user may manually reset the system. Further, the signal from the detection component may be transmitted to the cutout switches by means of wires or wireless systems.

### BRIEF DESCRIPTION OF THE DRAWINGS

The foregoing and other advantages of the invention and related methods will be appreciated more fully through consideration of the accompanying drawings wherein:

FIG. 1 depicts the smoke detection component together with the alarm system and signal transmitter.

FIG. 2 depicts the carbon monoxide detection component together with the alarm system and signal transmitter.

### DETAILED DESCRIPTION

As evidenced by the descriptive drawings provided herein, the inventive device provides for smoke and carbon monoxide detection systems. The device features embodiments such as a smoke and carbon monoxide component, an alarm component, transmitter system, cutout switches and valve system.

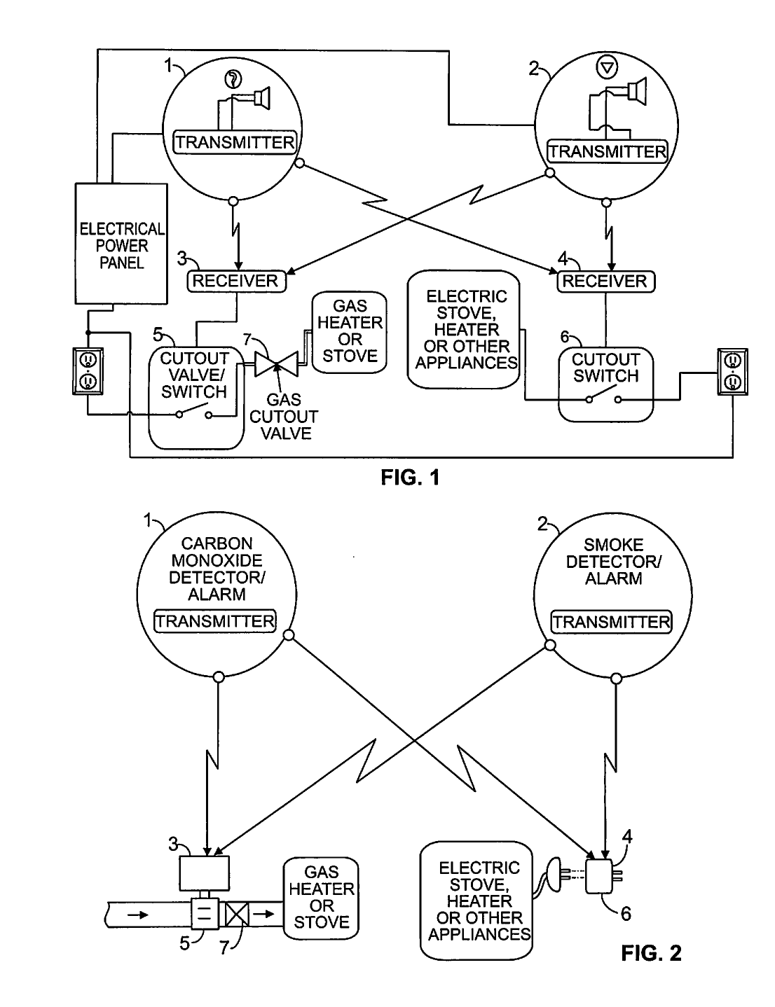

Referring further to FIG. 1, the smoke detection component is shown. Upon detection of airborne smoke particles the smoke detector component sounds an alarm alerting the inhabitants of the closed environment where the inventive device is retrofitted. Further, an electronic signal is transmitted activating the cutout switch component (FIGS. 1, 2). Transmission of the signal can be done either through electronic wirings or wireless transmitters. Upon activation of the cutout switch, a gas valve interrupts the electric or gas supply towards the units/appliances.

FIG. 2 depicts the carbon monoxide component. This mechanism detects carbon monoxide infiltrated inside a closed environment and signals to alert inhabitants where the invention is retrofitted. Further, an electronic signal is transmitted activating the cutout valve switch component (See, FIGS. 1, 2). The electronic signal is sent by means of radio frequency. Said signal ranges under 100 feet and outputs up to 100 milliwatts of power. The electronic signal can be transmitted by means of electric wires or wireless transmission methods. The electronic signal further activates the cutout switch system causing the power or gas supply to stop or shut off. A receiver is used to communicate the signal between the transmitter component and the cutout switch system.

Referring now to FIG. 1 the cutout switch component is electrically activated to open to shut off power to the units/appliances that are being monitored. The cutout valve depicted in FIG. 1 is used to electrically activate the shut off valve to shut off the gas supply. The valve is installed in the gas supply line (See FIG. 2) and is operated by the electric cutout valve switch. The switch electronically closes the valve. The gas switch receives its signal from the smoke or carbon monoxide alarm transmitter which sends it to the receiver component. The receiver then activates the switch which further shuts off the valve and then the gas supply.

As depicted in FIG. 1, the cutout switches and gas cutout valve components can be plugged into the wall outlet or hard wired. The units/appliances may then be plugged into the switch or the switch may be directly installed into the electrical outlet.

As an embodiment of the smoke and carbon monoxide detector, a sensor component which works at a sensitivity level of 1.3% obscuration/foot, nominal sensitivity is disclosed (See FIG. 2). An ionization sensor is used to detect smoke in a closed environment. Said sensor uses small amounts of radioactive material (americium-241) to ionize air. The process takes place in the ionization/sensing chamber. Resulting from the process is air that becomes conductive and permits current to flow between electrodes. The conductivity pertaining to the sensor may be set or reduced to a predetermined level. Therefore, whenever airborne smoke particles enter the ionization/sensing chamber, the conductivity level of the air decreases. When the level of conductivity gradually decreases to a predetermined level, the smoke and carbon monoxide alarm is turned on. The alarm component together with the rest of the system may be powered by 120 VAC or regular 9 volt alkaline batteries.

What is claimed:

1. FIG. 1. An apparatus designed to detect a condition in a closed environment, more specifically, airborne smoke and carbon monoxide particles, comprising: a smoke (#2) and carbon monoxide detector (#1), alarm, signal transmitter (#1 & #2, signal receiver (#3 & #4) and cutout switch system (#5 & #6) and gas cutout valve (#7).
A system wherein a smoke or carbon monoxide is detected, (will not respond to natural gas, propane, heat motion or other hazardous conditions.) the detecting device sends an electrical signal to the alarm horn and, simultaneously, to the signal transmitters which then sends a radio frequency signal to a signal receiver. No central computer, processing circuit or memory device is used in this system. The signal receiver is connected electrically to a cutout switch. The signal receiver, when activated, will send an electrical signal to the cutout valve switch causing the switch to open interrupting power to the gas cutout valve causing it to close or to the electrical cutout switch to the appliances causing an interruption of power to the appliances. The smoke detector (#2) sends out signals on two frequencies, one signal to the carbon monoxide signal receiver and a second signal to the smoke detector signal receiver, this action will then cause both cutout switches (#5 & #6) to be activated. The carbon monoxide transmitter transmits on a single frequency, the same frequency as does the smoke detector when sending a signal to the gas cutout valve/switch (#5). The cutout valve switch, when activated, will open, causing an interruption of electrical power to the gas valve which will then close shutting off the gas supply. Once this is activated, it must be reset manually.
A vacation switch is installed in both signal receivers in order to prevent the signal receivers from responding to the signal when not desired.

2: The smoke detector of claim 1, wherein the smoke detector is provided with a sensor to detect smoke particles inside a closed environment.
A. This smoke detector is designed to respond only to the presence of smoke. (will not detect the presence of gas, propane, heat toxic gas, infra-red sensors, ultra-violet sensors or any combinations thereof.)

3: The smoke detector in claim 1, wherein an alarm transmitter (#2) is used to further the signal to the signal receiver (#4)
A. Once the alarm is activated an electrical signal is sent to the alarm horn and, simultaneously, to the signal transmitter located in the detector. The smoke detector transmitter (#2), transmits on 2 different frequency signals, one frequency to the smoke detector receiver and a second signal to the carbon monoxide receiver. This detector is not designed to detect natural gas, propane, heat, or hazardous conditions.)

4: The carbon monoxide in claim 1, wherein said the carbon monoxide detector (#1) is provided with a sensor for detecting carbon monoxide particles inside a closed environment.
A. The carbon monoxide detector is designed to detect only carbon monoxide particles, this system is not designed to detect any other environmental conditions.

5: The carbon monoxide detector claim 1: wherein the transmitter is used to further the signal to the signal receiver by means of radio signals.
A. Once the alarm is activated an electrical signal is sent to the alarm horn and to the signal transmitter, located, in the detector, The signal transmitter sends a RF signal to the signal receiver which then sends an electrical signal to the gas cutout valve switch causing the power to be interrupted to the gas valve causing the valve to shift to the closed position. This invention does not evolve the use of any computers.

6: The alarm system in claim 1, wherein that when activated, is able to produce an audible sound.
A. This system will only alarm upon the detection of smoke or carbon monoxide. (Is not designed to detect the presence of heat, gas, hazardous environmental conditions, natural gas, propane gas, nor the detect non-environmental conditions, such as motion.

7: The system of claim 1, wherein the notification signal sends an electrical signal to the horn, in order to alert the presence of danger and, simultaneously, to the signal transmitter.
A. No notification system is used in this invention, has no system for notifying the user of a problem and no computer is used in this invention.

8: The transmitter in claim 1, wherein the transmitters are used to send an RF signal to the signal receivers from the alarm component.
A. This invention sends out a RF signal on one frequency and does not send out a plurality of sound waves. This system does not use a central computer, no means for notifying users of an occurrence.

9: The transmitter component of claim 1, wherein the transmitter may transmit an RF signal through wireless transmission method.
A. This invention has no means to send notification messages and does not involve a central computer.

10: The receiver component of claim 1, wherein the receiver receives a RF signal from the signal transmitter and sends an electrical signal to the cutout switch causing it to open interrupting the power supply.
A. No motion detector, timing device remote shut off devices are used in this invention. No central computer is used in this invention, and has no means to send messages to user.

11: The cutout switch component of claim 1, wherein the switch receives an electrical signal from the receiver component further operating the cutout valve.
A. No central computer or motion detectors are relied in this invention.

12: The cutout switch component of claim 1, wherein the cutout switch component (#5) opens causing the an interruption of power to the cutout valve.
A. This invention has no means for entering codes nor to recognize codes.

13: The cutout switch of claim 1, wherein the switch (#5 & 6) opens causing the gas valve to shut or the appliance cutout switch to open.
A. No codes may be entered in this invention, it has no memory system and has no means to communicate to the user.

14: The cutout switch system of claim 1, wherein said component is mounted ahead of the home units being monitored.
A. This system has no means to operate remotely, remote shut off or remotely controlling the flow of energy.

15: The cutout switch of claim 1: wherein the cutout switch (#5 & 6) will be plugged into an electrical power outlet or may be installed in the electrical outlet.
A. This cutout switch is actuated by electrical current from the receiver and does not respond to sound waves. It does not operate in conjunction with a central computer and no computers are used in this entire system. This invention has no means of detecting motion, no vibration switches, no flood control and has no ability to detect earthquakes.

16: The cutout device in claim 1, wherein the monitored units/appliances may be plugged into the cutout switch (#5 & #6).
A. This cutout switch is actuated by electrical current from the receiver and does not rely on sound waves. This invention does not operate through or in conjunction with a central computer This cutout device does not have the ability to detects earthquakes or floods and has no ability to disable power in the event of earthquakes or floods.

17. The cutout switch component of claim 1, wherein the cutout switch (#5 & 6) may be directly installed into an electrical outlet.
A. This cutout switch is actuated by an electrical signal and does not have the ability to operate on sound waves. This invention does not operate through or in conjunction with a central computer. This cutout device does not have the ability to detect earthquakes, floods or gas.

18. The cutout switch of claim 1, wherein the electrical cutout may be installed in the electrical outlet.
A. The cutout switch is installed in the outlet and is operated from an electrical signal from the signal receiver. This cutout switch is not controlled or operated by means of a computer. This system does not have the ability to detect vibration and has no function for detecting flood control.
